(19) United States
(12) Patent Application Publication
(10) Pub. No.: US 2008/0018665 A1
(43) Pub. Date: Jan. 24, 2008

(54) SYSTEM AND METHOD FOR VISUALIZING DRAWING STYLE LAYER COMBINATIONS

(76) Inventors: Jay Behr, San Francisco, CA (US); Mason Foster, Walnut Creek, CA (US)

Correspondence Address: John C. Carey;PATTERSON & SHERIDAN, L.L.P., Suite 1500, 3040 Post Oak Blvd., Houston, TX, 77056, US

(21) Appl. No.: 11/459,555

(22) Filed: Jul. 24, 2006

(51) Int. Cl. G09G 5/00

(52) U.S. Cl. 345/629

(57) ABSTRACT

One embodiment of the invention includes a method for generating a representation of a drawing style used by a computer aided design (CAD) drawing. Generally, users specify a selection a drawing style, and a CAD application may be configured to identify the style elements associated with each individual layer of the drawing style and to display a representation of the drawing style. Generally, the style elements associated with each layer may be displayed on an individual plate. The arrangement of the plates indicates an order in which the layers are applied to drawing elements having the drawing style.

### BACKGROUND OF THE INVENTION

1. Field of the Invention

The present invention generally relates to computer software. More specifically, the present invention relates to a system and method for presenting a visual display that conveys how multiple layers of a drawing style contribute to the overall definition and appearance of the drawing style.

2. Description of the Related Art

The term computer-aided design (CAD) generally refers to a broad set of computer software applications used by a variety of, artists, animators, designers, engineers and other professionals to create computer images such as construction blueprints, CAD models, animation sequences, CGI sequences, 3D models, and graphic displays, etc. Commonly, CAD applications allow users to apply a drawing style to elements of a digital image. For example, common style elements include shadings textures, colors, patterns, brush strokes, fill patterns, and digital effects such as “blur” or “brighten,” to name but a few. More generally, a drawing style may be used to define how any aspect of drawing elements included in a digital image, drawing, or video sequence appears to users.

The definition of a drawing style may be very simple. For example, a style applied to a line drawing may specify only the weight (or width) and color of a line. However, more complex drawing styles are typically defined using multiple “layers,” where all the style elements at one layer are applied to a drawing element before elements at another layer are applied. In general, the more complex a drawing style becomes, the more difficult it becomes to understand how each individual element (and each layer) contributes to the appearance of drawing elements to which the overall style definition is applied. Because of this, users often resort to adjusting a style definition by adjusting or turning on (or off) elements of a drawing style and then applying the drawing style to elements within a drawing to assess what impact the change produces. This process may then be repeated until a desired result is achieved. This ad-hoc trial and error approach is often quite tedious since users have to guess which element of which layer needs to be modified to achieve a desired result.

Additionally, the definition of a drawing style is commonly displayed using a list of elements that are included in that drawing style or using a display where elements of the drawing style are shown independently of one another. However, this approach often fails to convey how the order in which the layers of the drawing style are applied may affect the appearance of the drawing style.

Accordingly, there remains a need in the art for a way to present a drawing style that conveys how multiple layers and elements at each layer contribute to the overall definition and appearance of the drawing style, and that allows users to easily modify a drawing style to achieve a desired effect.

### SUMMARY OF THE INVENTION

Embodiments of the invention present users with a display of a drawing style definition (or more simply, just “drawing style”) in a manner that conveys how each element of the drawing style contributes to the style definition and that also allows a user to easily modify a drawing style to achieve a desired effect. Advantageously, with the invention, a user may modify a drawing style and immediately asses the impact of changes to the overall style definition, without having to perform a repetitive series of trial and error changes.

A drawing style may be defined to include multiple layers of style elements. In one embodiment, a style editor may be configured to display the multiple layers of a drawing style by rendering each layer on a separate “plate.” As described in greater detail herein, each plate may provide a graphical representation of the style elements included that layer of the drawing style. Each layer of a drawing style may itself include one or more elements (or complete drawing styles). In one embodiment, the plate at any given layer may be expanded to display each element of a given layer on a separate plate. Conversely, a display of a layer's elements may be collapsed together onto a single plate. When fully collapsed, the plates display the complete drawing style of all of the layers.

Further, the style editor may arrange the plates to indicate the order in which the layers are applied to elements of a CAD drawing. Thus, the plates may convey both the elements included in each layer of a drawing style and the order in which layers are applied. Accordingly, users can easily determine what impact re-ordering the layers may have on the overall drawing style. Still further, users may modify an element of a drawing style and have the changes reflected in a display of both the plate with the modified style element and by a composite view of the drawing style.

Modifications to a drawing style may include, among other things, adding or removing elements (or layers) from the drawing style, modifying the attributes of a particular style element, and changing the order in which different elements are applied.

One embodiment of the invention includes a method for generating a representation of a drawing style used by a CAD drawing. This method generally includes receiving a selected drawing style, where the selected drawing style specifies one or more layers of style elements to apply to drawing elements having the selected drawing style. The method further includes parsing the selected drawing style to identify the one or more layers of the selected drawing style and identifying a set of style elements associated with each layer. For each layer, the method includes displaying a representation of the layer where the style elements associated with the layer are displayed on a plate and where the arrangement of two or more plates indicates an order in which two or more layers are applied to drawing elements having the selected drawing style.

Another embodiment includes a method of managing drawing styles used by drawing elements of a CAD drawing. This method includes specifying a selection of a drawing style. The selected drawing style may include one or more layers of style elements to apply to drawing elements having the selected drawing style. Generally, each layer may have a set of style elements. This method also includes opening a style editor configured to provide a display representation of the drawing style. The style elements associated with each layer may be displayed on a plate. Additionally, the arrangement of two or more plates may indicate an order in which the style elements are applied to drawing elements having the selected drawing style. This method also includes modifying an attribute of the drawing style. For example, the drawing style may be modified by changing the arrangement of the two or more plates or by changing an attribute of a style element associated with one of the layers.

Still another embodiment of the invention includes a computer-readable medium storing instructions for generating a representation of a drawing style used by a CAD drawing, including instructions for performing the previously described methods.

### BRIEF DESCRIPTION OF THE DRAWINGS

FIG. 1 is a block diagram illustrating elements of a CAD application, according to one embodiment of the invention.

FIG. 2 illustrates a graphical user interface screen displaying a drawing canvas, a drawing palette, and a style gallery, according to one embodiment of the invention.

FIG. 3 illustrates a graphical user interface screen displaying an example of a drawing style applied to elements of a CAD drawing, according to one embodiment of the invention.

FIG. 4 illustrates a graphical user interface screen displaying a drawing style editing tool, according to one embodiment of the invention.

FIG. 5 further illustrates the drawing style editing tool shown in FIG. 4, according to one embodiment of the invention.

FIG. 6 illustrates an alternative configuration of the drawing style editing tool first shown in FIG. 4, according to one embodiment of the invention.

FIG. 7 illustrates a method for generating a visual display representation of the definition of a drawing style, according to one embodiment of the invention.

### DETAILED DESCRIPTION OF THE PREFERRED EMBODIMENTS

Embodiments of the invention are described herein using a CAD application configured to allow users to compose a CAD drawing from two dimensional (2D) line work (e.g., a set of lines, arcs, curves and points). However, the invention is not limited any particular CAD environment or to any particular type of computer generated images (CGI). Rather, embodiments of the invention may be adapted for use with a broad variety of CAD drawings including, architectural drawings (or portions thereof) such as a blueprint or scaled drawing of a construction project, rendered digital images used in a CGI sequence, such as a frame or scene used for an animation project, 2D or 3D digital models or drawings, and digital photographs modified using photograph editing software, to name but a few examples.

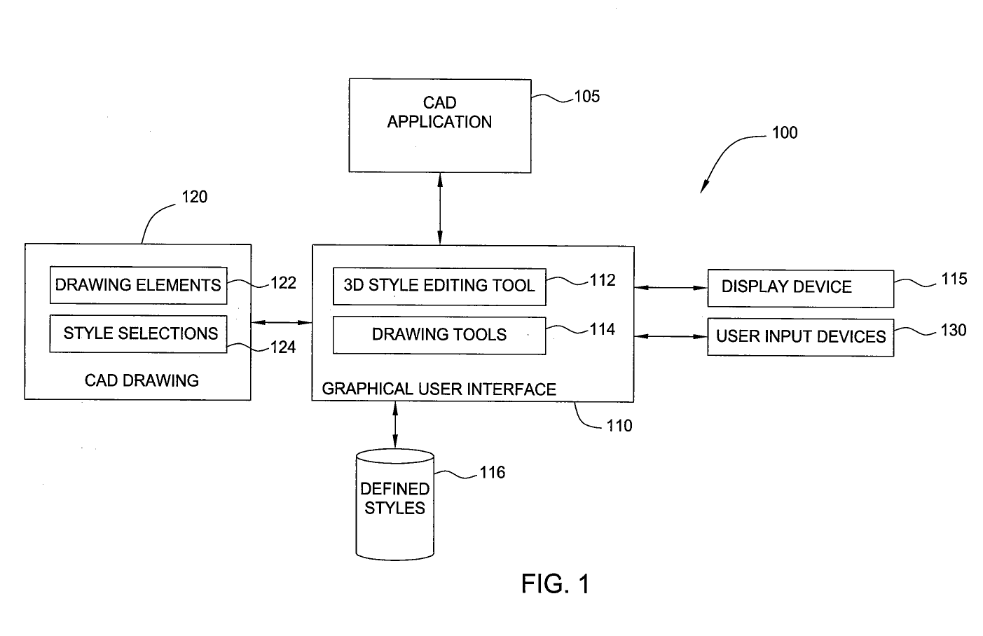

FIG. 1 is a block diagram illustrating a system 100 used to compose a CAD drawing 120, according to one embodiment of the invention. The components illustrated in system 100 are representative of computer software applications executing on existing computer systems, e.g., desktop computers, server computers, laptop computers, tablet computers, and the like. The software applications described herein, however, are not limited to any particular computing system and may be adapted to take advantage of new computing systems as they become available.

Additionally, the components illustrated in system 100 may be software applications executing on a single computer system or on distributed systems communicating over computer networks including local area networks or large, wide area networks, such as the Internet. For example, a graphical user interface 110 may be generated by a software program executing on a client computer system at one physical location that communicates with a CAD application 105 executing on another computer system in another physical location. Also, in one embodiment, CAD application 105 and graphical user interface 110 may be provided as an application program (or programs) stored on computer readable storage media such as a CD-ROM, DVD-ROM, disk, a flash memory module, or other tangible storage media.

As shown, the CAD system 100 includes, without limitation, CAD application 105, graphical user interface 110, CAD drawing 120, user input devices 130, and a display device 115. Typically, user input devices 130 include a mouse pointing device and a keyboard, and display device 115 is a CRT monitor or LCD display. In one embodiment, CAD application 105 is a software application allowing a user interacting with GUI interface 110 to generate a CAD drawing 120. Accordingly, CAD application 105 may include routines or instructions that allow users to create, edit, and save CAD drawing 120. For example, the Alias® or Maya® 3D modeling, animation, and visual effects suites, or the 3DS Max 3D modeler application, and associated utilities available from Autodesk®, Inc. may be used.

CAD drawing 120 is included to be representative of a variety of digital images generated using CAD application 105 and graphical user interface 110. As stated, examples of CAD drawing 120 include 2D or 3D line work drawings, CGI images, rendered scenes or frames of an animation sequence, and digital images generated by a scanning device or digital camera, to name but a few examples. More generally, CAD drawing 120 is representative of any digital image displayed using a, design, paint, drawing, or editing program that includes elements with a visual appearance that me be determined by applying a defined drawing style 116.

As shown, graphical user interface 110 includes a 3D style editing tool 112 drawing tools 114, and defined styles 116. Those skilled in the art will recognize, however, that the tools of GUI interface 110 shown in FIG. 1 are simplified to highlight aspects of the present invention and that a typical CAD application 105 and GUI interface 110 may include a broad variety of additional tools and features used to compose CAD drawing 120. Typically, users interact with GUI interface 110 and tools 112 and 114 to compose CAD drawing 120 (or other form of digital image). Illustratively, CAD drawing 120 may include a set of drawing elements and 122 and style selections 124. Drawing elements 122 represent components of the CAD drawing 120 to which a defined drawing style 116 may be applied. And style selections 124 represent a set of defined styles that have been selected to be applied to drawing elements 122.

For example, drawing tools 112 may allow a user to compose a CAD drawing 120 as a set of line work that includes points, lines, and/or curves. As described in greater detail herein, users may select to apply a drawing style from defined styles 116 to a particular drawing element. A defined style 116 may specify, among other things, line size, width, or appearance, shadings textures, colors, patterns, fills, and/or digital effects to be applied to a drawing element 122. When a defined style 116 is applied to a particular drawing element 122, that drawing element 122 takes on the appearance and characteristics specified by the defined style 116.

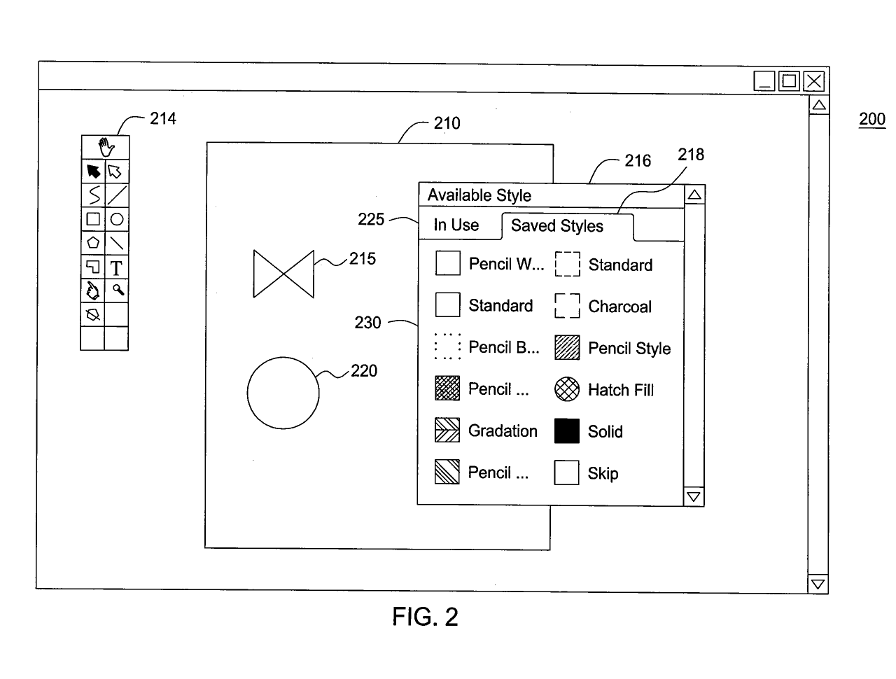

FIG. 2 illustrates a graphical user interface screen display 200 that includes a drawing canvas 210, a drawing palette 214, and a style gallery 216, according to one embodiment of the invention. Illustratively, drawing canvas 210 includes line work 215 and line work 220. As shown, no drawing styles have been applied to line work 215 or line work 220.

Drawing palette 214 provides an example of drawing tools 114. In one embodiment, a user may interact with drawing palette 214 to create and edit lines, circles, or other 2D shapes displayed on drawing canvas 210. One tool that may be selected from drawing palette 114 allows a user to open and display style gallery 216. As shown, style gallery 216 provides a composite image of defined styles 218. Illustratively, style gallery 216 provides a number of defined styles 218 related to the appearance, color or other attributes. Users may select one of defined styles 218 and apply that style to drawing elements 122, such as, line work 215 or line work 220. Of course, depending on the intended use of CAD application 105, style gallery 216 may present a variety of shadings textures, colors, patterns, fills, or digital effects appropriate for a given case. For example, the drawing styles available to a CGI animator composing a special effects sequence are likely to be different from the drawing styles used by an architect generating a scaled rendering of construction project or from a designer editing the appearance of a digital photograph.

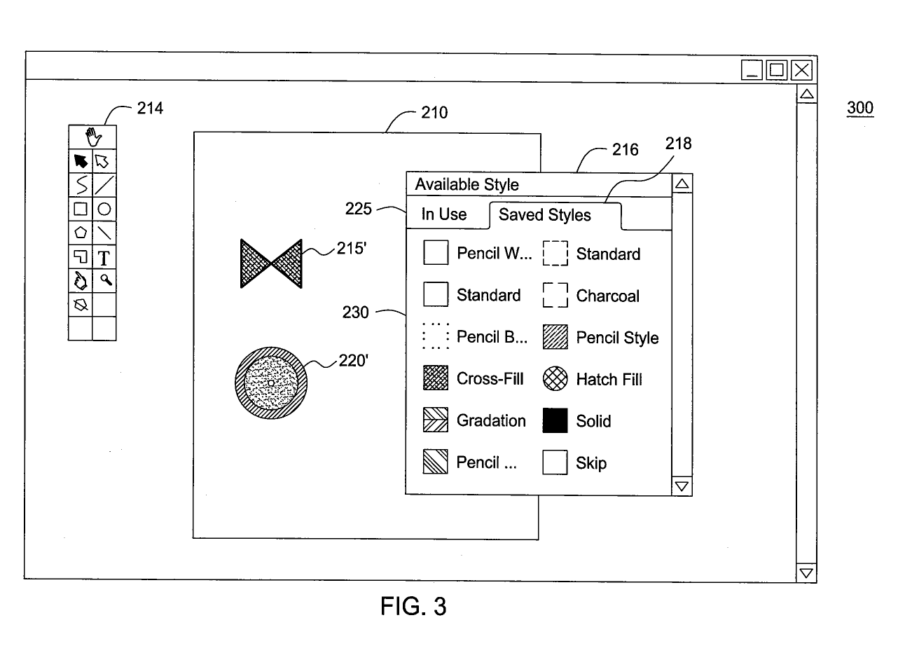

FIG. 3 illustrates a graphical user interface screen 300 displaying an example of drawing styles 218 applied to line work 215′ and 220′, according to one embodiment of the invention. As shown, when one of the drawing styles 218 is applied to line work 215′ and 220′, these elements take on the attributes, appearance, and characteristics specified by the particular drawing style applied to these elements. In one embodiment, if the style applied to a drawing element is changed, then the appearance of the drawing element may be updated to reflect the changes. For example, the drawing styles applied to line work 215′ and 220′ include a fill pattern applied to bounded regions. If the fill pattern for one of these drawing styles is modified, then the drawing element having the modified style may be updated as well.

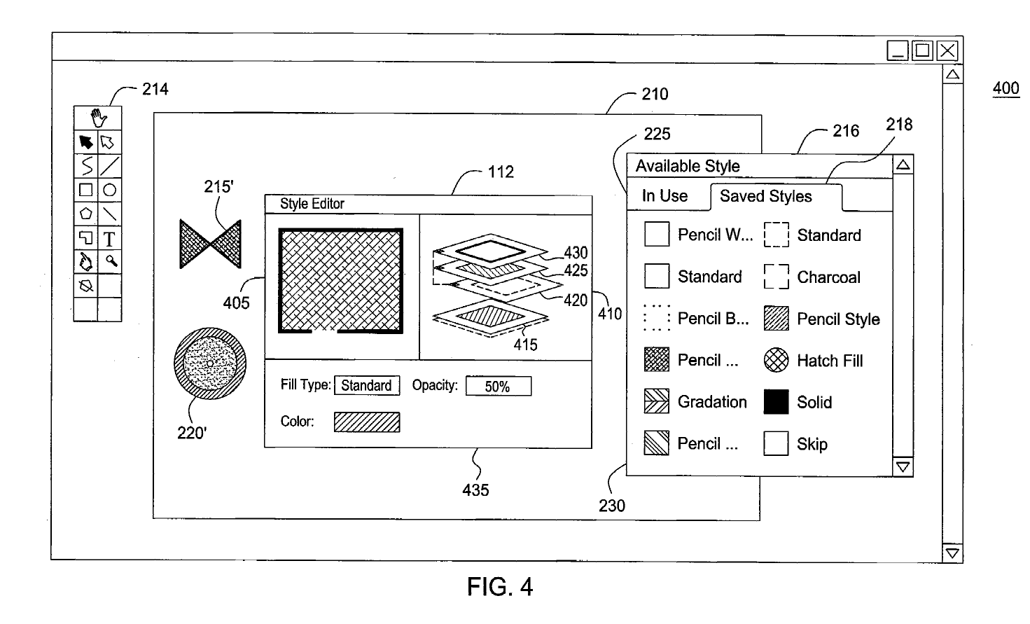

In one embodiment, users may edit the attributes, appearance, and/or characteristics of a defined style 218 displayed in style gallery 216 using style editing tool 112. For example, FIG. 4 illustrates a graphical user interface screen 400 displaying style editing tool 112, according to one embodiment of the invention. As shown, style editing tool 112 includes a composite display 405, a style layer display 410, and a properties display 435. Illustratively, style editor 112 displays the drawing style applied to line work 215′. Composite display 405 provides a visual representation of the complete drawing style applied to line work 215′. Layer display 410 provides a visual representation of each layer applied to line work 215′ on plates 415, 420, 425, and 430. Properties display 435 displays the attributes of a given style element that may be modified. In this example, properties display 435 shows the properties for the fill pattern displayed on plate 415.

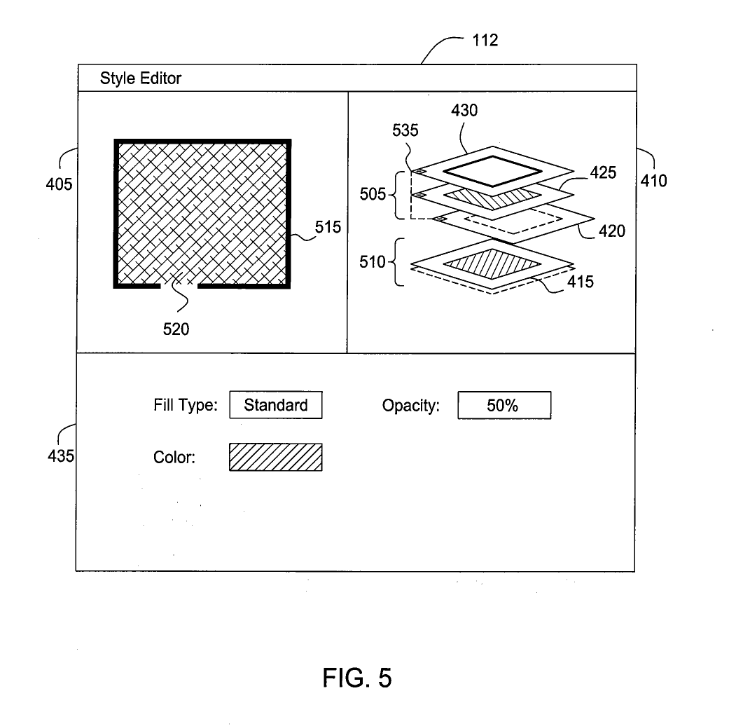

FIG. 5 further illustrates the style editing tool 112 of FIG. 4, according to one embodiment of the invention. As shown, style editing tool 112 includes composite display 405, layer display 410, and properties display 435. The layer display 410 includes plates 415, 420, 425, and 430. In this example, the drawing style displayed by style editor 112 includes two layers, an upper layer 505 and lower layer 510. Layer 510 includes a first fill pattern displayed on plate 415. Layer 505 includes three style elements displayed on plates 420, 425, and 430. Illustratively, the three elements of layer 505 are fully expanded so that each style element is displayed on a separate plate. In one embodiment, the style elements included in a given style layer may be expanded/collapsed using controls 535.

Plate 430 shows that line work having this drawing style should use a bold stroke pattern. The bold stroke pattern is reflected in composite display 405 by a bold border line 515. Layer 505 also includes plates 425 and 420. These two plates define a fill pattern with a color in plate 425 and a dashed brush stroke in plate 420. The drawing style resulting from the combination of the fill pattern shown in plate 415 and the fill pattern of plates 420 and 425 is reflected in composite display 405 by composite fill pattern 520.

In one embodiment, Layer display 410 may be configured to arrange plates 415, 420, 425, and 430 to reflect which style elements are related to one another and the drawing layers to which each style element belongs. Thus, users may easily determine which style elements need to be modified, added, or removed to achieve a desired effect. Further, the drawing style that results from a particular arrangement of layers may be readily determined from the layer display 410.

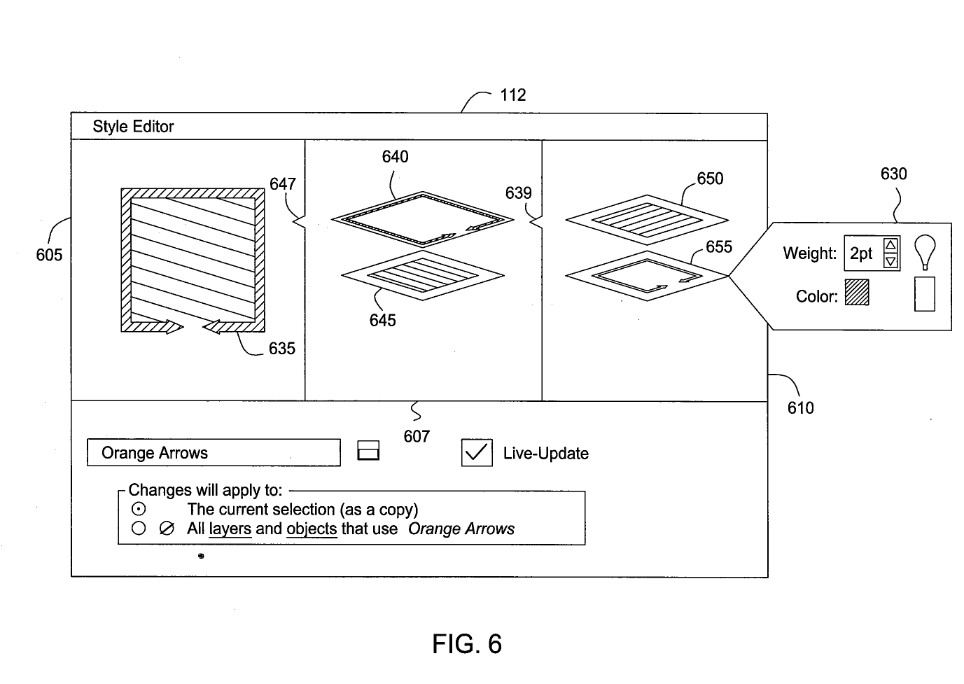

FIG. 6 illustrates style editing tool 112 of FIG. 4, according to one embodiment of the invention. In this example, plates 640-655 are used to present the layers of an “arrows” drawing style arranged horizontally, as opposed to the vertical stack as in FIGS. 4 and 5. Illustratively, the style elements of each layer may be represented on a separate plate with the style elements associated with a given layer out in separate panels running horizontally. As shown, the layers of composite “arrows” drawing style 635 (shown in panel 605) is displayed in panel 607 on plates 640 and 645. Arrow 647 indicates the composite style shown in panel 635 may be divided into the two layers shown in panel 607.

Illustratively, plate 640 includes style elements that specify endpoints with arrows and a line fill pattern using cross hatching lines which slant upwards from right to left. Plate 645 shows a fill pattern applied to bounded regions in a drawing represented using lines slanting downwards from right to left.

Arrow 639 indicates that the drawing style layer shown on plate 640 include multiple sub-elements. The elements of this layer are shown in panel 610. Specifically, panel 610 includes plate 650 showing the fill pattern applied to lines having the line style shown on plate 655. Also, plate 655 specifies the brush stroke width and color to use for drawing elements to which this style is applied. Like the configuration of style editor 112 shown in FIGS. 4 and 5, style editor 112 shown in FIG. 6 readily conveys each component of a drawing style. Further, a user may modify elements of a drawing style by selecting a particular plate. For example, as shown, plate 655 is selected and a properties display 630 may be used to change the properties (the width and color of the brush stroke) of this style element. Additionally, users may modify a given style by changing the order of the layers associated with a drawing style.

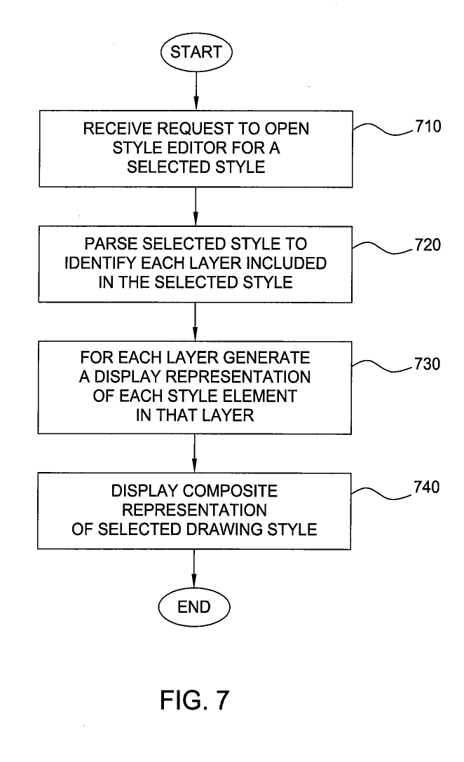

FIG. 7 illustrates a method 700 for generating a visual display of a drawing style, according to one embodiment of the invention. Persons skilled in the art will understand that any system configured to perform the method shown in FIG. 7, in any order, is within the scope of the present invention.

Method 700 begins at step 710 where a request to open style editor 112 for a selected drawing style is received. Style editor 112 may be opened using a variety of user interface mechanisms. For example, a user may interact with tool palette 214 to open style editor 112, style gallery 216 may be configured to open style editor 112 when a user “double clicks” on a drawing style displayed in the style gallery 216, or context sensitive menu selections may be used (e.g., when a user right clicks on a drawing element, the GUI interface 110 may be configured to present a menu that includes a selection of “edit drawing style for this element”). Of course, no particular user interface mechanism is required.

Once the style editor 112 is invoked, at step 720, the definition of the selected drawing style is parsed to identify each layer (and within each layer, each style element) that is included in the selected drawing style. At step 730, for each layer identified at step 720, style editor 112 may be configured to display a plate with a representation of the style elements that are part of an individual layer. Depending on how style editor 112 is configured, the display of style layers may initially display each layer fully expanded or collapsed. At step 740, a composite representation of the selected drawing style may also be displayed. Thus, users may be simultaneously presented with both the “whole” and the “parts” of a given drawing style

Advantageously, embodiments of the invention provide a style editor that displays how each layer (and each style element included in each layer) contributes to an overall drawing style, and that also allows a user to easily modify a drawing style to achieve a desired effect. Thus, the user may modify a drawing style and immediately asses the impact of changes to the overall drawings style, without having to perform a repetitive series of trial and error changes. Because the plates convey both the elements included a drawing style and the sequence in which those elements are applied, users can easily determine what impact re-ordering various style elements may have on a given drawing style, as well as determine which style element is related to a given aspect of the composite appearance of a selected drawing style.

While the foregoing is directed to embodiments of the present invention, other and further embodiments of the invention may be devised without departing from the basic scope thereof, and the scope thereof is determined by the claims that follow.

What is claimed is:

1. A method for generating a representation of a drawing style used by a computer aided design (CAD) drawing, the method comprising:
receiving a selected drawing style, wherein the selected drawing style specifies one or more layers of style elements to apply to drawing elements having the selected drawing style;
parsing the selected drawing style to identify the layers of the selected drawing style;
identifying a set of style elements associated with each layer; and
for each layer, displaying a representation of the layer, wherein the set of style elements associated with the layer are displayed on a plate, and wherein the arrangement of two or more plates indicates an order in which two or more layers are applied to drawing elements having the selected drawing style.

2. The method of claim 1, further comprising, displaying a composite representation of the drawing style.

3. The method of claim 1, further comprising moving a selected one of the plates from an initial location to a target location, and re-displaying the representation of the drawing style.

4. The method of claim 1, further comprising modifying an attribute associated with a selected style element.

5. The method of claim 4, wherein the attribute comprises a line size, line width, brush stroke, appearance, shading, texture mapping, color, pattern, fill pattern, or digital effect to apply to drawing elements having the drawing style.

6. The method of claim 1, wherein the CAD drawing is an architectural or construction drawing, a rendered digital image used in a CGI sequence, a frame or scene used for an animation sequence, a two- or three-dimensional digital model or a digital photograph.

7. The method of claim 1, wherein the layers are displayed using a vertical arrangement, and wherein the order in which the layers are applied to drawing elements having the drawing style is based on the vertical stacking.

8. The method of claim 1, wherein the layers are displayed using a horizontal arrangement.

9. The method of claim 1, wherein a plate corresponding to a layer having two or more style elements may be expanded to show each style element of the layer associated on a separate plate.

10. A computer-readable medium storing instructions for generating a representation of a drawing style used by a computer aided design (CAD) drawing, including instructions for performing the steps of:
receiving a selected drawing style, wherein the selected drawing style specifies one or more layers of style elements to apply to drawing elements having the selected drawing style;
parsing the selected drawing style to identify the one or more layers of the selected drawing style;
identifying a set of style elements associated with each layer; and
for each layer, displaying a representation of the layer, wherein the style elements associated with the layer are displayed on a plate, and wherein the arrangement of two or more plates indicates an order in which two or more layers are applied to drawing elements having the selected drawing style.

11. The computer-readable medium of claim 10, wherein the steps further comprise displaying a composite representation of the drawing style.

12. The computer-readable medium of claim 10, wherein the steps further comprise moving a selected one of the plates from an initial location to a target location, and re-displaying the representation of the drawing style.

13. The computer-readable medium of claim 10, wherein the steps further comprise modifying an attribute associated with a selected style element.

14. The computer-readable medium of claim 13, wherein the attribute comprises a line size, line width, brush stroke, appearance, shading, texture mapping, color, pattern, fill pattern, or digital effect to apply to drawing elements having the drawing style.

15. The computer-readable medium of claim 10, wherein the CAD drawing is an architectural or construction drawing, a rendered digital image used in a CGI sequence, a frame or scene used for an animation sequence, a two- or three-dimensional digital model or a digital photograph.

16. The computer-readable medium of claim 10, wherein the layers are displayed using a vertical arrangement, and wherein the order in which the layers are applied to drawing elements having the drawing style is based on the vertical stacking.

17. The computer-readable medium of claim 10, wherein the layers are displayed using a horizontal arrangement.

18. The computer-readable medium of claim 10, wherein a plate corresponding to a layer having two or more style elements may be expanded to show each style element of the layer associated on a separate plate.

19. A method of managing drawing styles used by drawing elements of a CAD drawing, comprising:
specifying a selection of a drawing style, wherein the selected drawing style includes one or more layers of style elements to apply to drawing elements having the selected drawing style, and wherein each layer has a set of style elements associated with the layer;
opening a style editor configured to provide a display representation of the drawing style, wherein the style elements associated with each layer are displayed on a plate, and wherein the arrangement of two or more plates indicates an order in which the style elements of the two or more layers are applied to drawing elements having the selected drawing style; and
modifying an attribute of the drawing style.

20. The method of claim 19 wherein the attribute of the drawing style is modified by changing the arrangement of the two or more plates.

21. The method of claim 19, wherein the attribute of the drawing style is modified by changing an attribute of a style element associated with one of the layers.
